(19) United States
(12) Patent Application Publication
(10) Pub. No.: US 2009/0066976 A1
(43) Pub. Date: Mar. 12, 2009

(54) PRINTING APPARATUS

(75) Inventors: Hiroto UCHIDA, Chigasaki-shi (JP); Susumu Sakio, Sammu-shi (JP); Hideo Takei, Sammu-shi (JP); Mitsuru Yahagi, Chigasaki-shi (JP); Junpei Yuyama, Chigasaki-shi (JP); Akira Sawamori, Chigasaki-shi (JP); Shigeru Endoh, Chigasaki-shi (JP); Michiharu Sugimoto, Chigasaki-shi (JP)

Correspondence Address: KRATZ, QUINTOS & HANSON, LLP, 1420 K Street, N.W., Suite 400, WASHINGTON, DC, 20005, US

(73) Assignee: ULVAC, INC., Chigasaki-shi (JP)

(21) Appl. No.: 12/259,638

(22) Filed: Oct. 28, 2008

Related U.S. Application Data
(63) Continuation of application No. PCT/JP07/58618, filed on Apr. 20, 2007.

(30) Foreign Application Priority Data
May 1, 2006 (JP) 2006-127396

(51) Int. Cl. B41J 2/015; G06K 15/12

(52) U.S. Cl. 358/1.7; 347/20

(57) ABSTRACT

A printing apparatus free from contamination of dust into a coated layer is provided. A printing apparatus of this application includes a first ejecting head and a printing head. The first ejecting head is located on a leading side in a moving direction D of the printing head. Since electric charge is removed from an object to be printed and dust is removed therefrom, by blowing an electric charge-removing gas through the first ejecting head before an ink lands on the object to be printed, dust does not contaminate a coated layer. In addition, since a suction hole is arranged between an ejecting hole and a nozzle zone, a stream of the electric charge-removing gas is not formed in the nozzle zone, and thus a meniscus of nozzles is not disturbed.

This is a Continuation of International Application No. PCT/JP2007/058618 filed Apr. 20, 2007, which claims priority to Japan Patent Application No. 2006-127396, filed on May 1, 2006. The entire disclosures of the prior applications are hereby incorporated by reference herein in their entireties.

### BACKGROUND

The present invention generally relates to a printing apparatus for printing by discharging a coating liquid through a nozzle.

Heretofore, an ink jet printer (a printing apparatus) has been used to form an oriented film or a color filter for a liquid crystal display device.

More specifically, after a coated layer is formed by discharging an ink, in which an oriented film material (a resin, for example) or a coloring material is dissolved or dispersed, through a nozzle, and landing it on a surface of a substrate, a desired film is formed by removing an excess solvent from the coated layer through drying.

However, in a case in which an oriented film or a color filter is formed on a large-scale substrate, it takes time from the start to the termination of the printing. There is a difference in an evaporation amount of the solvent between an ink applied immediately after the start of the printing and an ink applied immediately before the termination of the printing, thereby resulting in dry spots.

In order to prevent the lack of the applied ink and in order to form a thick film, the ink is discharged in such a way that the ink that has previously landed may overlap with the ink that lands afterward.

Since the ink-overlapped portions are thicker than the other portions, there is a problem in that the overlapped portions remain linearly when the ink is dried as it is.

When the solvent evaporating from the ink or droplets of the ink generating on landing are attached to a printing apparatus, the apparatus becomes contaminated. Particularly when the solvent or the droplets attach to the nozzle or therearound, there is a problem in that the discharge amount of the ink through the nozzle becomes unstable.

In addition, since the above-described substrate, an insulating substrate such as a glass substrate or a plastic substrate is ordinarily used, the substrate is likely to be electrostatically charged. When the substrate is electrostatically charged, there is a problem in that dust or the like is adsorbed onto the substrate, and that the dust causes contamination in the film formation process. See, Japanese Patent No. 3248685 and patent document No. JP A 2003-297569.

### SUMMARY OF THE INVENTION

The present invention has been accomplished to solve the above problems, and is to provide a printing apparatus, which forms neither dry spots nor uneven film thicknesses, and causes neither contamination of the printing apparatus nor contamination of dust during the film forming process.

In order to solve the above-mentioned problems, the present invention is directed to the printing apparatus, which includes a printing head and first moving means for moving the printing head, and is configured to discharge an ink toward an object to be printed, while the printing head is being moved. The printing apparatus further includes a first ejecting head which is arranged at a leading side in a moving direction of the printing head and to which a first gas is to be fed, an ionizer which is arranged in the first ejecting head and generates an electric charge-removing gas by ionizing the first gas, an ejecting hole which is formed at that position of the first ejecting head which faces the object to be printed and which ejects the electric charge-removing gas toward the object to be printed, and a suction hole which is positioned at a place between the ejecting hole of the first ejecting head and the printing head and is connected to a gas-sucking suction unit, wherein the first ejecting head and the printing head are movable together by the first moving means.

The present invention is directed to the printing apparatus, further including a second ejecting head which is arranged on a rear side in the moving direction of the printing head and to which a second gas is to be fed, an ejecting hole which is formed at that position of the second ejecting head which faces the object to be printed and which ejects the second gas toward the object to be printed, and a suction hole which is positioned between the ejecting hole of the second ejecting head and the printing head and is connected to the suction unit, wherein the second ejecting head is movable together with the printing head and the first ejecting head.

The present invention is directed to the printing apparatus, including an ultrasonic wave generator arranged inside the second ejecting head for irradiating ultrasonic waves together with the second gas.

The present invention is directed to the printing apparatus, including an ionizer arranged inside the second ejecting head for ionizing the second gas, wherein the first moving means is configured to reciprocate the printing head and the first and second ejecting heads.

The present invention is directed to the printing apparatus, comprising second moving means configured to move the printing head relative to the first and second ejecting heads.

Since dust is removed by blowing the electric charge-removing gas onto the object to be printed before the ink lands on the object, no dust is contaminated in a coated layer. Since neither the electric charge-removing gas nor the drying gas enters the nozzle, a meniscus is not disturbed, so that the discharging through the nozzle is stabilized. Since the drying gas is blown onto the object after the ink lands, the ink is rapidly dried, so that no dry spots are formed. Since a solvent evaporating from the ink or droplets of the ink are removed through sucking, neither contamination of the printing apparatus nor that of a working environment occurs. Since the coated layer is made flat with the ultrasonic waves after the ink lands, the thickness of the film becomes uniform.

### BRIEF DESCRIPTION OF THE DRAWINGS

FIGS. 1 (a) and (b) are a plan view and a sectional view illustrating one embodiment of the printing apparatus according to the present invention.

FIG. 2 is an enlarged sectional view of a first ejecting head.

FIG. 3 is an enlarged sectional view of a second ejecting head.

FIG. 4 is a plan view illustrating another embodiment of the printing apparatus according to the present invention.

FIG. 5 is an enlarged sectional view of first and second ejecting heads.

### DETAILED DESCRIPTION OF THE EMBODIMENTS

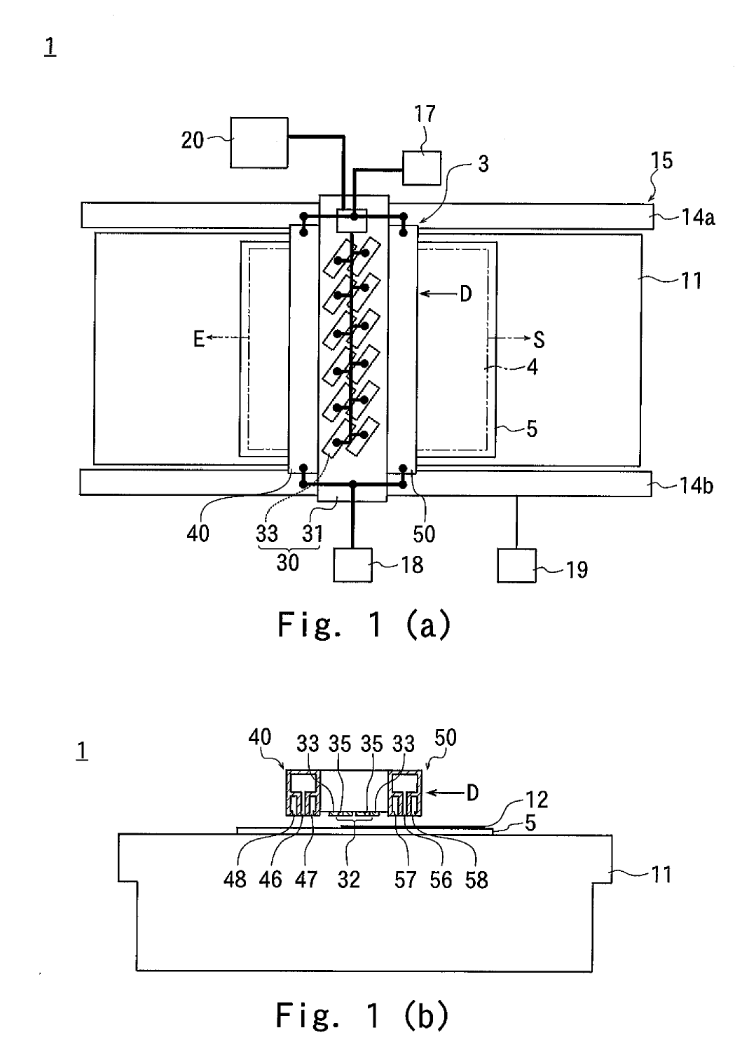

In FIG. 1(a), a reference numeral 1 denotes one embodiment of the printing apparatus according to the present invention.

This printing apparatus 1 includes a mounting table 11, a printing mechanism 3 arranged above the mounting table 11, and moving means 15 for moving the printing mechanism 3 above the mounting head 11.

The moving means 15 includes rails 14a, 14b and a motor 19. The printing mechanism 3 is placed on the rails 14a, 14b, and is configured to be movable along the prolongation direction of the rails 14a, 14b by a driving power of the motor 19.

The printing mechanism 3 includes a printing head 30, and first and second ejecting heads 40, 50; and the printing head 30 is in an elongated shape.

The printing head 30 includes a holder 31 and discrete heads 33. In this embodiment, the number of the discrete heads 33 is plural. The respective discrete heads 33 are arranged at the holder 31 on a side of the mounting table 11 in one row or a plurality of rows.

One or a plurality of nozzles 35 are provided at faces of the respective discrete heads 33 on the side of the mounting table 11 (FIG. 1(b)). An ink feeding system 20 is arranged outside the printing mechanism 3. Each of the discrete heads 33 is connected to the ink feeding system 20, and the ink fed from the ink feeding system 20 is discharged toward the mounting table 11 through the nozzles 35.

The discrete heads 33 are so arranged that the nozzles 35 are arranged in one or a plurality of rows. In FIG. 1(b), a reference numeral 32 denotes a nozzle zone in which rows of the nozzles 35 are arranged. The rows of the nozzles 35 are across the moving direction of the printing mechanism 3. It is configured that when the ink is discharged through each nozzle 35 while the printing mechanism 3 is moving, the ink can land on predetermined areas.

The first ejecting head 40 is arranged on a side of one long side of the printing head 30, and the second ejecting head 50 is arranged on a side of the other long side of the printing head 30. Since the nozzles 35 are provided for the printing heads 30, the nozzle zone 32 is located between the first and second ejecting heads 40, 50.

The longitudinal direction of the printing head 30 is across the moving direction of the printing mechanism 3. Therefore, the first ejecting head 40, the nozzle zone 32 and the second ejecting head 50 are arrayed along the moving direction of the printing mechanism 3.

A gas feeding system 17 and a suction unit 18 are arranged outside the printing mechanism 3. The first and second ejecting heads 40, 50 are connected to the gas feeding system 17 and the suction unit 18 via flexible pipes, respectively.

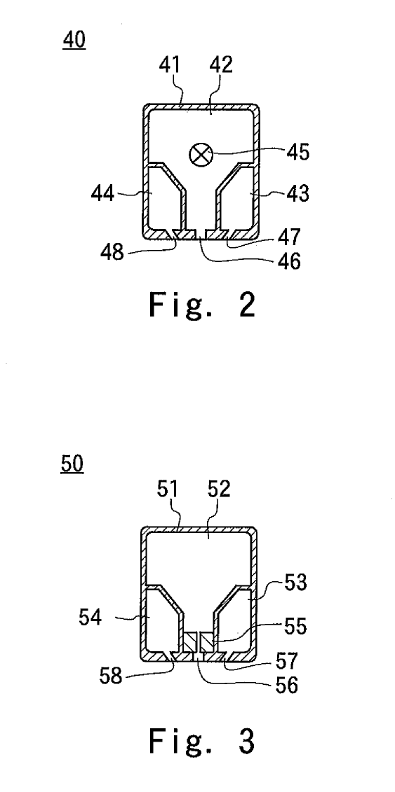

FIG. 2 and FIG. 3 are enlarged sectional views of the first and second ejecting heads 40, 50.

The first and second ejecting heads 40, 50 have head bodies 41, 51, respectively. Buffer chambers 42, 52 are provided inside the respective head bodies 41, 51. The gas is fed into the each of the buffer chambers 42, 52 from the above-mentioned gas feeding system 17.

Ejecting holes 46, 56 are respectively provided in the bottom walls of the head bodies 41, 51 that face the mounting table 11. One end of each of the ejecting holes 46, 56 (first and second ejecting holes 46, 56) is connected to the buffer chamber 42, 52, respectively, and the other is connected to the exterior atmosphere. Therefore, the buffer chambers 42, 52 are connected to the exterior atmosphere through the ejecting holes 46, 56, respectively.

In FIGS. 1(a) and (b), a sign D denotes the moving direction of the printing mechanism 3 when the printing mechanism moves, while discharging the ink through the nozzles 35. When the ejecting head at the leading side of that moving direction D is taken as the first head 40 and the ejecting head at the rear side as the second ejecting head 50, an ionizer 45 is provided in the buffer chamber 42 of the first ejecting head 40.

The ionizer 45 is connected to a power source (not shown) When corona discharge is generated inside the ionizer 45 by passing current through the ionizer 45, the gas fed into the buffer chamber 42 is ionized, and an electric charge-removing gas, which is ejected through the ejecting hole 46, is generated.

On the other hand, since no ionizer is provided in the second ejecting head 50, no ionization occurs. Thus, the non-ionized gas (drying gas) is ejected through the ejecting hole 56 of the second ejecting head 50.

In this embodiment, an ultrasonic wave generator 55 is provided inside the buffer chamber 52 of the second ejecting head 50. The ultrasonic wave generator 55 is disposed in the vicinity of the ejecting hole 56 inside the buffer chamber 52. When the gas is fed into the buffer chamber 52 while the ultrasonic wave generator 55 is operated, ultrasonic oscillation is transmitted to an object to be printed, together with a stream of the drying gas.

As mentioned above, the first ejecting head 40 is positioned ahead of the second ejecting head 50 in the moving direction D. Accordingly, when the electric charge-removing gas and the drying gas are blown upon while the printing mechanism 3 is being moved, the electric charge-removing gas and the drying gas are blown onto a band-like area along the moving direction D.

The ejecting holes 46, 56 are constituted by slender slits or a plurality of through-holes arranged in one or two or more rows. The first and second ejecting heads 40, 50 are directed in such a manner that the longitudinal direction or the row-arranged direction of the ejecting holes 46, 56 crosses the moving direction D. Therefore, the area onto which the electric charge-removing gas is blown upon and the area onto which the drying gas is blown upon have widths corresponding to the lengths of the respective ejecting holes 46, 56.

Suction chambers 43, 44 and suction chambers 53, 54 are provided inside the head bodies 41, 51, respectively. The suction chambers 43, 44, 53, 54 are connected to the above-mentioned suction unit 18. Suction holes 47, 48 (first suction holes 47, 48) and suction holes 57, 58 (second suction holes 57, 58) are provided in the bottom walls of the head bodies 41, 51, respectively. One ends of the suction holes 47, 48 and suction holes 57, 58 are connected to the suction chambers 43, 44, 53, 54, respectively, and the other ends are connected to the exterior atmosphere.

When the suction chamber 43, 44, 53, 54 are evacuated by the suction unit 18, their internal pressures become lower than that of the exterior atmosphere, so that the gas in the exterior atmosphere is sucked through the suction holes 47, 48, 57, 58.

The suction holes 47, 57 are respectively provided at a place between the ejecting holes 46, 56 and the nozzle zone 32, and the gas which goes toward the nozzle zone 32 through the ejecting holes 46, 56 is sucked via the ejecting holes 47, 57. Consequently, a gas stream flowing in the nozzle zone 32 is not generated, so that neither the electric charge-removing gas nor the drying gas enters the nozzles 35.

In this embodiment, the nozzle zone 32 is sandwiched between the ejecting holes 46, 56, and suction holes 48, 58 are positioned at the other side of the nozzle zone 32. Therefore, that gas of the electric charge-removing gas and the drying gas which goes outwardly around the printing mechanism 3 is also sucked.

The suction holes 47, 48, 57, 58 are constituted by slender slits or a plurality of through-holes arranged in one or two or more rows. The longitudinal direction (or the arranged direction) of the suction holes 47, 48, 57, 58 is made substantially in parallel to the arranged direction of the ejection holes 46, 56.

The longitudinally opposite ends or the opposite ends of the row of the suction holes 47, 48, 57, 58 are identical with the longitudinally opposite ends or the opposite ends of the row of the ejecting holes 46, 56 or project outwardly therefrom. Therefore, the gas ejected through each portion of the ejecting holes 46, 56 is uniformly sucked through the suction holes 47, 48, 57, 58.

Next, steps of forming a coated layer on an object to be printed, by using this printing apparatus 1, will be explained. FIG. 1 shows a state in which the object 5 to be printed is placed at a predetermined position on the mounting table 11. In this figure, a reference numeral 4 denotes a printing area on which the coated layer is to be formed on the object 5 to be printed.

First, the printing mechanism 3 is moved in a direction opposite to the above-mentioned moving direction D, so that it is located at a starting position S outside the printing area 4. When the printing mechanism 3 is located at the starting position S, the first ejecting head 40, the nozzle zone 32 and the second ejecting head 50 are arranged in the mentioned order from a side near the printing area 4.

Ejection of the electric charge-removing gas and the drying gas, generation of the ultrasonic oscillation, and suction through the suction holes 47, 48, 57, 58 are started; and the printing mechanism 3 is moved from the starting position S along the moving direction D, while the ejection of the electric charge-removing gas and the drying gas, the generation of the ultrasonic oscillation and the suction through the suction holes 47, 48, 57, 58 are being continued. When the whole printing mechanism 3 moves to a terminating position E on the opposite side of the starting position S via the printing area 4, the ejection of the electric charge-removing gas and the drying gas, the generation of the ultrasonic oscillation and the suction through the suction holes 47, 48, 57, 58 are stopped.

When the length of the printing area 4 in a direction perpendicular to the moving direction D is taken as the width of the printing area 4, the length of the slit or the row of the ejecting holes 46, 56 is larger than the width of the printing area 4, and the opposite ends of the slit or the row of the ejecting holes 46, 56 are identical to the edges of the printing area 4, or protrude outwardly therefrom. When the printing mechanism 3 moves to the terminating position E, the electric charge is removed by blowing the electric charge-removing gas onto the entire printing area 4. Consequently, adhesion force of particles (dust) to the object 5 to be printed decreases, so that the particles are blown away with the electric charge-removing gas, and removed from the printing area 4.

As mentioned above, since the suction holes 47, 48 are provided on the opposite sides of the ejecting hole 46 of the first ejecting head 40, the particles are sucked through the suction holes 47, 48, 57, 58 together with the electric charge-removing gas, so that the particles will not be reattached to the object 5 to be printed. The length of the nozzle zone 32 is larger than the width of the printing area 4, and the opposite ends of the nozzle zone 32 are identical to the edges of the printing area 4 or project therefrom. Accordingly, the ink can land on the printing area 4 at a predetermined interval from one end to the other in the width direction.

Therefore, if the discharge of the ink is started when the nozzle zone 32 enters the printing area 4 from the starting position S, and if the discharge of the ink is stopped when the nozzle zone 32 goes out from the printing area 4 to the terminating position E, the ink lands on the entire printing area 4.

Since the electric charge is removed from the printing area 4 before the ink lands, the ink-landed position is not deviated. In addition, since the particles are removed from the printing area 4, they are not contaminated in the coated layer 12 with the ink.

Since the suction holes 47, 57 are provided between the ejecting holes 46, 56 and the nozzle zone 32, as mentioned above, no gas stream is generated in the nozzle zone 32, and droplets of the ink formed upon discharging or upon landing are sucked through the suction holes 47, 57.

Therefore, neither the electric charge-removing gas nor the drying gas enters the nozzles 35, and the surrounding area of the nozzles 35 is not stained with the ink droplets. Consequently, the meniscus is not disturbed inside the nozzles 35, and the ink is stably discharged.

As mentioned above, since the opposite ends of the slit or the row of the ejecting hole 56 of the second ejecting head 50 are identical to the edges of the printing area 4 or protrude therefrom, the drying gas is blown all over the coated layer 12 formed on the printing area 4, so that the solvent is evaporated and removed away from the ink forming the coated layer 12.

In this embodiment, since the ultrasonic oscillation is irradiated to the coated layer 12 together with the stream of the drying gas, the coated layer 12 is made flat with the ultrasonic oscillation when the coated layer 12 is dried. Accordingly, the coated layer 12 is made flat and dried.

Since the second ejecting head 50 includes the suction hole 58 behind the ejecting hole 56 in the moving direction D, the solvent which is evaporated and removed away from the coated layer 12 is sucked through the suction hole 58. Thus, the vapor amount of the solvent leaking outside the printing mechanism 3 is small, so that the contamination of the working environment is prevented.

After the printing mechanism 3 reaches the terminating position E, the object 5 on which the coated layer 12 is formed is removed from the mounting table 11, the printing mechanism 3 is moved to the direction reversed to the moving direction D and returned to the starting position S again, in a state in which the discharging of the ink is stopped. Then, a coated layer 12 can be formed on a fresh object 5 to be printed.

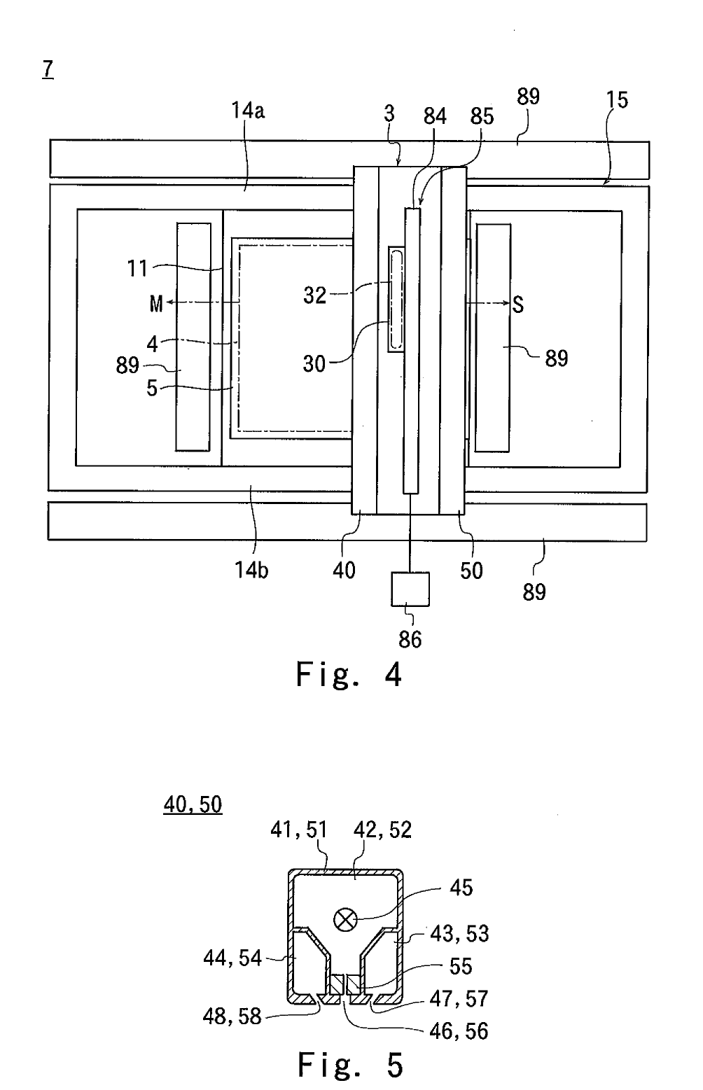

Heretofore, explanation has been made of the case where the ink is discharged only when the printing mechanism 3 moves in one direction. However, the present invention is not limited thereto. In FIG. 4, a reference numeral 7 denotes another embodiment of the printing apparatus according to the present invention. This printing apparatus 7 is identical to the printing apparatus 1 in FIG. 1 with respect to the moving means (the first moving means) 15 for moving the printing mechanism 3 and the constitutions of the first and second ejecting heads 40, 50, and the magnitude relationship between the length of the ejecting holes 46, 56 and the width of the printing area 4, but the printing apparatus 7 is different from the printing apparatus 1 in that the printing apparatus 7 includes a second moving means 85 besides the first moving means 15, a nozzle zone 32 differs in breadth, and each of the first and second ejecting heads 40, 50 is provided with an ionizer 45 and an ultrasonic wave generator 55.

The ionizer 45 and the ultrasonic wave generator 55 are individually switchable. In the first or second ejecting head 40, 50, when the ionizer 45 is operated, the electric charge-removing gas is ejected through the ejecting holes 46, 56, while the drying gas is ejected in the state that the ionizer 45 is stopped. On the other hand, if the ultrasonic wave generator 55 is operated when the drying gas is ejected, the ultrasonic oscillation can be transmitted together with the stream of the drying gas.

The second moving means 85 includes a linear guide 84 and a motor 86. When the driving power of the motor 86 is transmitted to the printing head 30, the printing head 30 can be reciprocated at a position between the first and second ejecting heads 40, 50 along the prolongation directions of the guide 84.

Neither the first ejecting head 40 nor second ejecting head 50 is moved by the second moving means 85, but they stand stationary relative to the guide 84. The second moving means 85 moves the printing head 30 relative to the first and second ejecting heads 40, 50.

The prolongation direction of the guide 84 crosses the moving direction of the printing mechanism 3, so that the moving direction in which the printing head 30 moves relative to the first and second ejecting heads 40, 50 crosses the moving direction of the printing mechanism 3.

Process for forming a coated layer 12 with this printing apparatus 7 will be explained. First, the printing mechanism 3 is moved to the starting position S outside the printing area 4 by the first moving means 15.

In this embodiment, when the printing mechanism 3 is at the starting position S, the ejecting head near the printing area 4 is taken as the first ejecting head 40, and the ejecting head remote from the printing area 4 is taken as the second ejecting head 50. The ejection of the electric charge-removing gas through the first ejecting head 40, the ejection of the drying gas through the second ejecting head 50, the generation of the ultrasonic waves inside the second ejecting head 50 and the suction through each suction hole 47, 48, 57, 58 is started.

Next, while the printing head 30 is kept stationary relative to the first and second ejecting heads 40, 50, the ejection of the electric charge-removing gas and the drying gas, and the generation and the suction of the ultrasonic waves are continued. In this state, the printing mechanism 3 is moved in such a manner that the first ejecting head 40 is at the head of the moving direction.

When the printing mechanism 3 entirely moves to the returning position M on a side opposite to the starting position S via the printing area 4, the movement of the printing mechanism 3 is stopped, and the ejection of the electric charge-removing gas and the drying gas, and the generation and the suction of the ultrasonic waves are stopped.

While the printing mechanism 3 moves, the discharging of the ink is started when the nozzle zone 32 enters the printing area 4 from the starting position S, and the discharging of the ink is stopped when the nozzle zone 32 goes out to the returning position M from the printing area 4. Thus, the coated layer 12 is formed in a band-like shape along the moving direction of the printing mechanism 3.

The length of the nozzle zone 32 of the printing apparatus 7 is made smaller than the width of the printing area 4. When the nozzle zone 32 goes out to the returning position M, the coated layer 12 is not formed entirely over the printing area 4, and a portion where the coated layer 12 is not formed remains along the moving direction of the printing mechanism 3 in the printing area 4.

While the printing mechanism 3 is kept stationary at the returning position M, the printing head 30 is moved in the direction crossing the moving direction of the printing mechanism 3. Therefore, the printing head 30 is displaced in such a manner that in the below-mentioned returning path, the nozzle zone 32 may pass the portion where the coated layer 12 is not formed.

When the printing mechanism 3 is located above the returning portion M, the second ejecting head 50 is near the printing area 4, and the first ejecting head 40 is remoter from the printing area 4 as compared to the second ejecting head 50.

The ejection of the electric charge-removing gas through the second ejecting head 50, the ejection of the drying gas through the first ejecting head 40, the generation of the ultrasonic waves inside the first ejecting head 40 and the suction through each of the suction holes 47, 48, 57 and 58 are started. While the ejection of the electric charge-removing gas and the drying gas, and the generation and the suction of the ultrasonic waves are continued, the printing mechanism 3 is moved from the returning position M back to the starting position S.

When the printing mechanism 3 returns toward the starting position S from the returning position M, the printing head 30 is positionally moved from when the printing mechanism 3 goes toward the returning position M from the starting position S, whereby the printing head 30 moves above the portion where the coated layer 12 is not formed. Consequently, the printing head 30 passes the portion where the coated layer 12 has not been formed.

Therefore, if the discharge of the ink is started when the nozzle zone 32 enters the printing area 4 from the returning position M and if the discharging of the ink is stopped when it goes out to the starting position S from the printing area 4, a band of a coated layer 12 is formed at the portion where the coated layer 12 has not been formed when the printing mechanism 3 had gone toward the returning position M.

In this embodiment, the length of the nozzle zone 32 is ½ of the width of the printing area 4 or longer. When the printing mechanism 3 moves toward the returning position M, one end of the nozzle zone 32 is identical with one end of the printing area 4 in the width direction or projects therefrom. Further, when the printing mechanism moves in the returning path, one end of the nozzle zone 32 overlaps with the coated layer 12 formed when the printing mechanism goes toward the returning position M. If the other end is made identical with the other end of the printing area 4 in the width direction or protrudes therefrom, the coated layer 12 is formed all over the printing area 14 only by reciprocating the printing mechanism 3 once.

When the formation of the coated layer 12 is finished, the printing mechanism 3 returns to the starting position S, so that even if the printing mechanism 3 is not moved to another position, a fresh object 5 to be printed can be started to be coated with the ink.

Similar to the printing apparatus 1 shown in FIG. 1, in the printing apparatus 7, the electric charge-removing gas is blown on the object before the ink lands, and the drying gas is blown thereon after the ink lands thereon. Therefore, the coated layer 12 is obtained in a uniform film thickness without particles being contaminated therein.

In this embodiment, the printing apparatus 7 has exhaust units 89 arranged in the surrounding of the mounting table 11. A vapor of the solvent not entirely sucked through the suction holes 47, 48 is sucked by the exhaust units 89. Further, if the mounting table 11 is covered with a lid member not shown, a space surrounded by the lid member and the mounting table 11 is filled with the vapor of the solvent, so that the contamination of the working environment with the vapor of the solvent does not occur.

If the length of the nozzle zone 32 is smaller than ½ of the width of the printing area 4, the coated layer can be formed all over the printing area 4 by moving the printing mechanism 3 at one reciprocation and one-way path or more.

The above explanation has been made of a case in which the ultrasonic oscillation is irradiated to the coated layer 12 on the object 5 to be printed together with the drying gas. However, the present invention is not limited thereto. The drying gas may be blown onto the coated layer 12 without the application of the ultrasonic oscillation.

The invention is not limited to the case in which the suction holes 47, 48, 57, 58 are provided on the opposite sides of the ejecting holes 46, 56. If the suction holes 47, 57 are provided at least between the ejecting holes 46, 56 and the nozzle zone 32, neither the electric charge-removing gas nor the drying gas reaches the nozzles 35, and thus the discharge amount through the nozzles 35 is stabilized.

The printing apparatuses 1, 7 are particularly suitable for the formation of the coated layer 12 when prevention of contamination of the particles and uniformity in the film thickness are required.

Specifically, an oriented film-forming method is recited in which an oriented film made of a resin film is formed by applying an ink in which a resinous material (such as, a polyimide resin or the like) is dispersed or dissolved in a solvent.

The above explanation has been made of the case in which the coated layer 12 is formed all over the printing area 4. However, the present invention is not limited thereto. Coated layers 12 can be formed at intervals at predetermined positions of the object 5 to be printed by discharging the ink when the nozzles 35 are positioned above the predetermined positions of the object 5.

Specifically, a color filter or a PLED film may be formed by landing, within predetermined positions (pixels) of an object 5 to be printed, an ink in which a coloring material or a PLED (polymer light-emitting diode) is dispersed or dissolved in a solvent. In this case, the color filter or the PLED film is also formed in a uniform film thickness, free from contamination of particles, by using the printing apparatus 1, 7 according to the present invention.

The kind of the object 5 to be printed is not particularly limited. For example, when the oriented film, the color filter or the PLED film is to be formed, the object 5 to be printed is a glass substrate having electrodes formed on a surface.

The kind of gas to be fed into the first and second ejecting heads 40, 50 is not particularly limited. For example, N₂, O₂, air or the like may be used. Two or more kinds of these gases may be mixed and fed to the identical ejecting head. Further, the kind of the gas may be changed for each of the first and second ejecting heads 40, 50.

The installation position of the ionizer 45 is not limited to the buffer chamber 42. Any position may be acceptable so long as the gas is ionized before being ejected through the ejecting hole 46. For example, the ionizer 45 may be provided for the gas feeding system 17, and the ionized electric charge-removing gas is fed into the first ejecting head 40 or the second ejecting head 50.

The ionizer 45 used in the present invention is a device which generates +ions and −ions in order to neutralize the charged object with the oppositely polar ions and remove the static electric charge.

As the ionizer 45, an AC type static electric charge-removing device or a DC type static electric charge-removing device, for example, can be used.

The AC type static electric charge-removing device raises an alternative-current power source to a high voltage (not less than AC 4 kV and not more than 7 kV) and produces plus and minus ions at a timing of a commercial frequency (50 Hz or 60 Hz). This static electric charge-removing device has various kinds of devices and is for easy handling. A static electric charge-removing device in which an effective region for the removal of the static electric charge is widened by an assist such as a blow air (air ejection) can be used.

The DC type static electric charge-removing device is different from the AC type in that it has plus and minus electrodes; and high voltages are applied to the plus and minus electrodes, respectively. The DC type static electric charge-removing device is characterized in that since the timing for generating ions can be controlled or the plus and minus ions can be simultaneously and independently produced, ion dispersion is good, and a static electric charge-removing effect is obtained even if the device is remote from the charged object.

As the DC type static electric charge-removing device, there are further a SSDC (steady-state) type and a pulse DC type. In the SSDC type, ions are simultaneously generated by continuously applying a high voltage to both of the plus and minus electrodes. This differs from the other types in that the ions are simultaneously and continuously generated.

The pulse DC type produces ions by alternatively applying a direct-current high voltage to emitters of the plus and the minus, respectively. A static electric charge-removing effect can be obtained, which is applicable to the installation environment and the working environment by controlling the timing of its pulses (frequency).

What is claimed is:

1. A printing apparatus, which includes a printing head and a first moving means for moving the printing head and is configured to discharge an ink toward an object to be printed, while the printing head is being moved, the printing apparatus comprising:
a first ejecting head, which is arranged at a leading side in a moving direction of the printing head and to which a first gas is to be fed; and
an ionizer which is arranged in the first ejecting head and generates an electric charge-removing gas by ionizing the first gas,
wherein a first ejecting hole is formed at a position of the first ejecting head which faces the object to be printed and which ejects the electric charge-removing gas toward the object to be printed,
wherein a first suction hole is positioned at a place between the ejecting hole of the first ejecting head and the printing head and is connected to a gas-sucking suction unit, and
wherein the first ejecting head and the printing head are movable together by the first moving means.

2. The printing apparatus according to claim 1, further comprising:
a second ejecting head which is arranged on a rear side in the moving direction of the printing head and to which a second gas is to be fed,
wherein a second ejecting hole is formed at a position of the second ejecting head which faces the object to be printed and which ejects the second gas toward the object to be printed,
wherein a second suction hole is positioned between the ejecting hole of the second ejecting head and the printing head and is connected to the suction unit, and
wherein the second ejecting head is movable together with the printing head and the first ejecting head.

3. The printing apparatus according to claim 2, further comprising an ultrasonic wave generator arranged inside the second ejecting head for irradiating ultrasonic waves together with the second gas.

4. The printing apparatus according to claim 2, further comprising an ionizer arranged, inside the second ejecting head, for ionizing the second gas,
wherein the first moving means is configured to reciprocate the printing head and the first and second ejecting heads together.

5. The printing apparatus according to claim 4, further comprising a second moving means configured to move the printing head relative to the first and second ejecting heads.
